(19) United States
(12) Patent Application Publication
(10) Pub. No.: US 2011/0267543 A1
(43) Pub. Date: Nov. 3, 2011

(54) PICTURE SIGNAL PROCESSING APPARATUS AND PICTURE SIGNAL PROCESSING METHOD

(75) Inventor: Hirotoshi MIYAZAWA, Fukaya-shi (JP)

(73) Assignee: Kabushiki Kaisha Toshiba

(21) Appl. No.: 13/181,135

(22) Filed: Jul. 12, 2011

Related U.S. Application Data
(62) Division of application No. 11/519,796, filed on Sep. 13, 2006.

(30) Foreign Application Priority Data
Sep. 30, 2005 (JP) 2005-285759

(51) Int. Cl. H04N 5/14

(52) U.S. Cl. 348/672; 348/E05.062

(57) ABSTRACT

According to one embodiment, a picture signal processing apparatus comprises an acquisition unit which acquires histogram data on each luminance level from luminance signals for one frame, a frequency converter unit which eliminates histogram data that corresponds to a no-image portion displayed so as to occupy a predetermined region in a screen from among the acquired histogram data, a creation unit which creates a nonlinear correction processing table for applying a nonlinear correction processing to the input luminance signal on the basis of the histogram data subjected to a frequency conversion processing, and a processing unit which applies a nonlinear correction processing to the input luminance signal on the basis of the created nonlinear correction processing table.

### CROSS-REFERENCE TO RELATED APPLICATIONS

This application is based upon and claims the benefit of priority from Japanese Patent Application No. 2005-285759, filed Sep. 30, 2005, the entire contents of which are incorporated herein by reference.

### BACKGROUND

1. Field

One embodiment of the invention relates to an improvement of a picture signal processing apparatus and a picture signal processing method for applying a gradation correction processing to a luminance signal on the basis of a luminance histogram.

2. Description of the Related Art

As is well known, in recent years, large screen displays of flat panel type have been developed, the screen displays being commercially available for use in television broadcast receivers or the like. In the meantime, in a large screen display of this type, a gradation correction processing is applied to luminance components of a picture signal in order to clearly visualize a display image.

As such a gradation correction processing relevant to luminance components, there is known a technique for carrying out the operation in accordance in a histogram distribution of luminance of an input picture signal. A basic concept of this technique is that a slope of a gradation correction characteristic curve is increased in response to a luminance level that is high in frequency of luminance histograms, and a slope of a gradation correction characteristic curve is decreased in response to a luminance level that is low in frequency of luminance histograms.

In this manner, by expanding a dynamic range for a luminance level region that occupies a majority of the input picture signal, improvement of a contrast sense of a picture is promoted or correction is made so that a fine gradation difference can be efficiently expressed.

In the meantime, it is assumed that picture signals are input as in a letterbox system or in a side panel system, the signals being displayed collectively so as to occupy a predetermined region in a screen. In this case, in a technique for generating a gradation correction characteristic curve by acquiring a histogram of luminance from a whole screen, a histogram of a no-image portion that is valueless as an image occupies some percentages of all, and thus, an advantageous effect of the gradation correction processing relevant to an effective image portion is reduced.

In Jpn. Pat. Appln. KOKAI Publication No. 2005-86772, there is disclosed a configuration of automatically setting a correction quantity limit value in response to a luminance distribution of read image data, and producing gradation correction characteristics so as to carry out gradation correction. However, there is nowhere given a description of troubleshooting a picture signal such that a no-image portion occupies several percentages of the whole screen.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram depicting an embodiment of the present invention, the diagram being adapted to explain a picture signal processing system of a television broadcast receiver;

FIG. 2 is a block diagram adapted to explain details on a picture signal processing unit of the television broadcast receiver in the embodiment;

FIG. 3 is a block diagram adapted to explain details on a signal correction unit of the picture signal processing unit in the embodiment;

FIG. 4 is a block diagram adapted to explain details on a luminance nonlinear correction processing unit of the signal correction unit in the embodiment;

FIG. 5 is a flow chart adapted to explain a processing operation of the luminance nonlinear correction processing unit in the embodiment;

FIG. 6 is a view adapted to explain a range of acquiring histogram data for one frame by the luminance nonlinear correction processing unit in the embodiment;

FIG. 7 is a view adapted to explain histogram data for one frame acquired by the luminance nonlinear correction processing unit in the embodiment;

FIG. 8 is a view adapted to explain a range of acquiring histogram data that corresponds to a no-image portion by the luminance nonlinear correction processing unit in the embodiment;

FIG. 9 is a view adapted to explain a setting range of a luminance level that corresponds to a no-image portion by the luminance nonlinear correction processing unit in the embodiment;

FIG. 10 is a view adapted to explain a result obtained by detecting a predetermined value or more from histogram data that corresponds to a no-image portion by means of the luminance nonlinear correction processing unit in the embodiment;

FIG. 11 is a view adapted to explain a result obtained by detecting a predetermined value or more from histogram data that corresponds to a no-image portion by means of the luminance nonlinear correction processing unit in the same embodiment, and then, applying data processing thereto;

FIG. 12 is a view adapted to explain histogram data obtained after a frequency conversion processing in the embodiment; and

FIG. 13 is a view adapted to explain an LUT for luminance nonlinear correction processing, the LUT being created from histogram data obtained after a frequency conversion processing in the same embodiment.

### DETAILED DESCRIPTION

Various embodiments according to the invention will be described hereinafter with reference to the accompanying drawings. In general, according to one embodiment of the invention, a picture signal processing apparatus comprises: an acquisition unit which acquires histogram data on each luminance level from luminance signals for one frame; a frequency converter unit which eliminates histogram data that corresponds to a no-image portion displayed so as to occupy a predetermined region in a screen from among the acquired histogram data; a creation unit which creates a nonlinear correction processing table for applying a nonlinear correction processing to the input luminance signal on the basis of the histogram data subjected to a frequency conversion processing; and a processing unit which applies a nonlinear correction processing to the input luminance signal on the basis of the created nonlinear correction processing table.

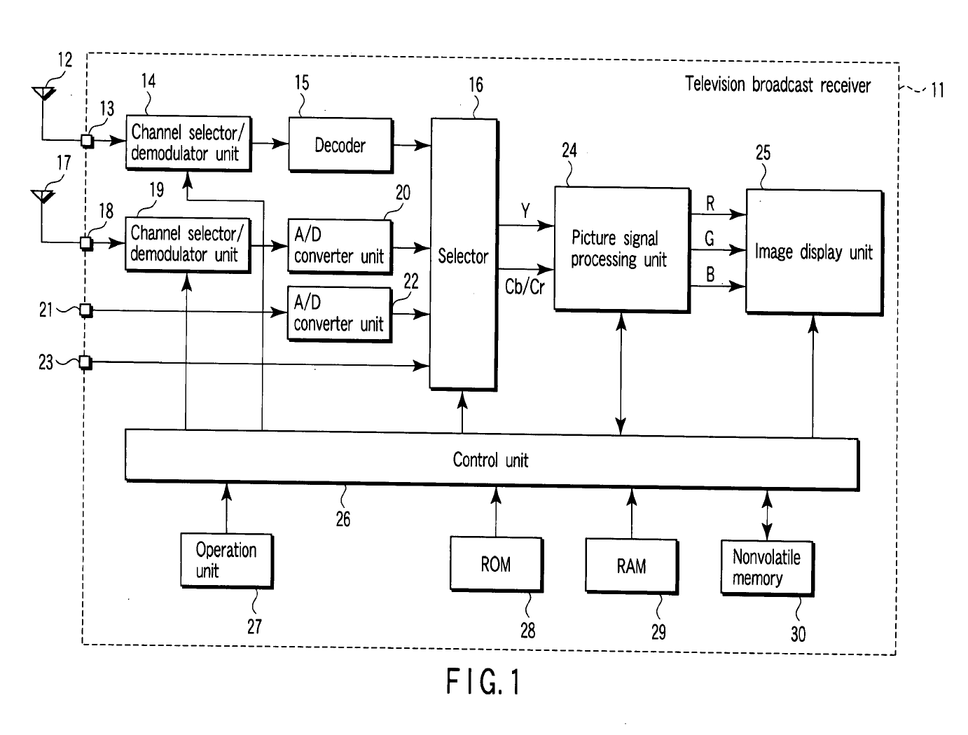

FIG. 1 schematically depicts a picture signal processing system of a television broadcast receiver 11 which is explained in the present embodiment.

That is, a digital television broadcast signal received by an antenna 12 for receiving digital television broadcast is supplied to a channel selector/demodulator unit 14 via an input terminal 13. The channel selector/demodulator unit 14 selects a broadcast signal of a desired channel from an input digital television broadcast signal, demodulates the selected signal, and outputs the demodulated signal to a decoder 15.

Then, the decoder 15 applies a decoding processing to the signal input from the channel selector/demodulator unit 14, thereby generating a digital luminance signal Y and a color signal Cb/Cr, respectively, and outputting the generated signals to a selector 16.

In addition, an analog television broadcast signal received by an antenna 17 for receiving analog television broadcast is supplied to a channel selector/demodulator unit 19 via an input terminal 18. The channel selector/demodulator unit 19 selects a broadcast signal of a desired channel from an input analog television broadcast signal, demodulates the selected signal, and generates an analog luminance signal Y and an analog color signal Cb/Cr, respectively.

Then, the analog luminance signal Y and color signal Cb/Cr generated by the channel selector/demodulator unit 19 are supplied to an analog/digital (A/D) converter unit 20, the supplied signals are converted to a digital luminance signal Y and a digital color signal Cb/Cr, and then, the converted signals are output to the selector 16.

In addition, the analog luminance signal Y and color signal Cb/Cr supplied to an external input terminal 21 for analog picture signals are supplied to an A/D converter unit 22, the supplied signals are converted to the digital luminance signal Y and color signal Cb/Cr, and then, the converted signals are output to the selector 16. Further, the digital luminance signal Y and color signal Cb/Cr supplied to an external input terminal 23 for digital picture signals are supplied to the selector 16 as they are.

Here, the selector 16 selects one of the digital luminance signal Y and color signal Cb/Cr supplied, respectively, from the decoder 15, the A/D converter units 20 and 22, and the external input terminal 23, and supplies the selected signal to a picture signal processing unit 24.

The picture signal processing unit 24, although a detailed description will be given later, generates R (red), G (green), and B (blue) signals by applying a predetermined signal processing to the input digital luminance signal Y and color signal Cb/Cr.

Then, the R, G, and B signals generated by the picture signal processing unit 24 are supplied to an image display unit 25 to be provided for image display. As the image display unit 25, for example, there is employed a flat panel display composed of a surface electric field display, a liquid crystal display, a plasma display, and the like.

Here, a variety of operations of the television broadcast receiver 11, including the various receiving operations described above, are integrally controlled by means of a control unit 26. The control unit 26 is a microprocessor that incorporates a central processing unit (CPU) and the like. The control unit receives operational information from an operation unit 27 that includes a remote controller (not shown), and controls the respective units so that its contents of operation are reflected.

In this case, the control unit 26 mainly utilizes a read only memory (ROM) 28 having stored therein a control program executed by a CPU thereof, a random access memory (RAM) 29 for providing a work area to the CPU, and a nonvolatile memory 30 in which a variety of setting information and control information, etc. are stored.

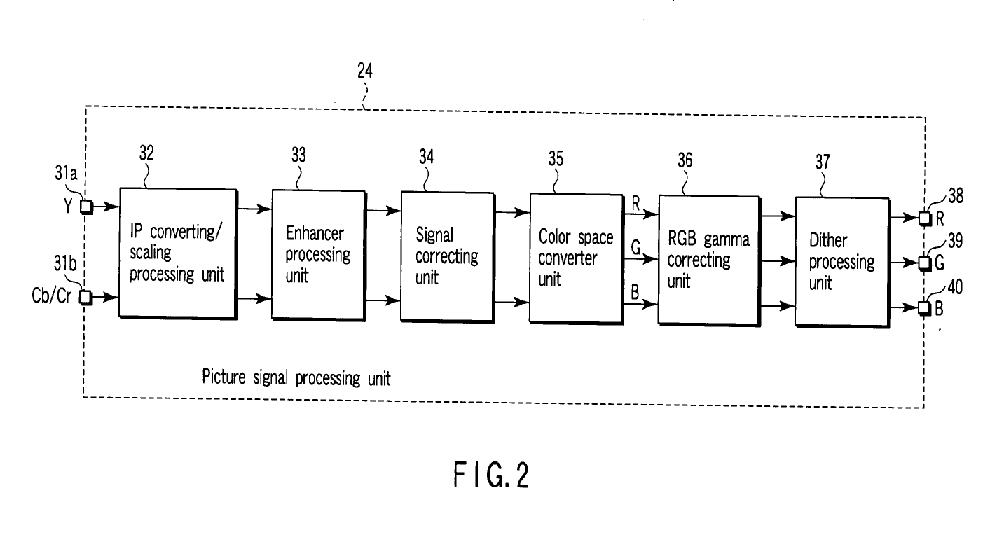

FIG. 2 shows an example of the above-described picture signal processing unit 24. That is, the digital luminance signal Y and color signal Cb/Cr selected by the selector 16 are supplied to an interlace progressive (IP) converting/scaling processing unit 32 via input terminals 31a and 31b.

In order to make a display at the image display unit 25 (flat panel display composed of surface electric field display, liquid crystal display, plasma display and the like), the IP converting/scaling processing unit 32 applies a progressive conversion processing and a scaling processing to the input luminance signal Y and color signal Cb/Cr, and outputs the resulting signals to an enhancer processing unit 33.

The enhancer processing unit 33 applies to the input luminance signal Y and color signal Cb/Cr an enhancer processing of making steep a rise in vertical and horizontal directions or changing sharpness, thereby outputting the resulting signal to a signal correcting unit 34.

The signal correcting unit 34 applies a nonlinear correction processing for gradation correction to the input luminance signal Y, and applies an amplitude control processing to the color signal Cb/Cr concurrent with the nonlinear correction processing to output the resulting signals to a color space converter unit 35.

The color space converter unit 35 converts the input luminance signal Y and color signal Cb/Cr into R, G, and B signals, and outputs the converted signals to an RGB gamma correcting unit 36. The RGB gamma correcting unit 36 applies white balance adjustment to the input R, G, and B signals, and applies a gamma correction processing to the image display unit 25 to output the resulting signals to a dither processing unit 37.

The dither processing unit 37 applies to the input R, G and B signals a compression processing of converting high gradation bit expression whose bit count has been extended in order to improve expressiveness into low gradation bit count that corresponds to the image display unit 25, and then, outputs the resulting signals to the image display unit 25 via output terminals 38, 39 and 40.

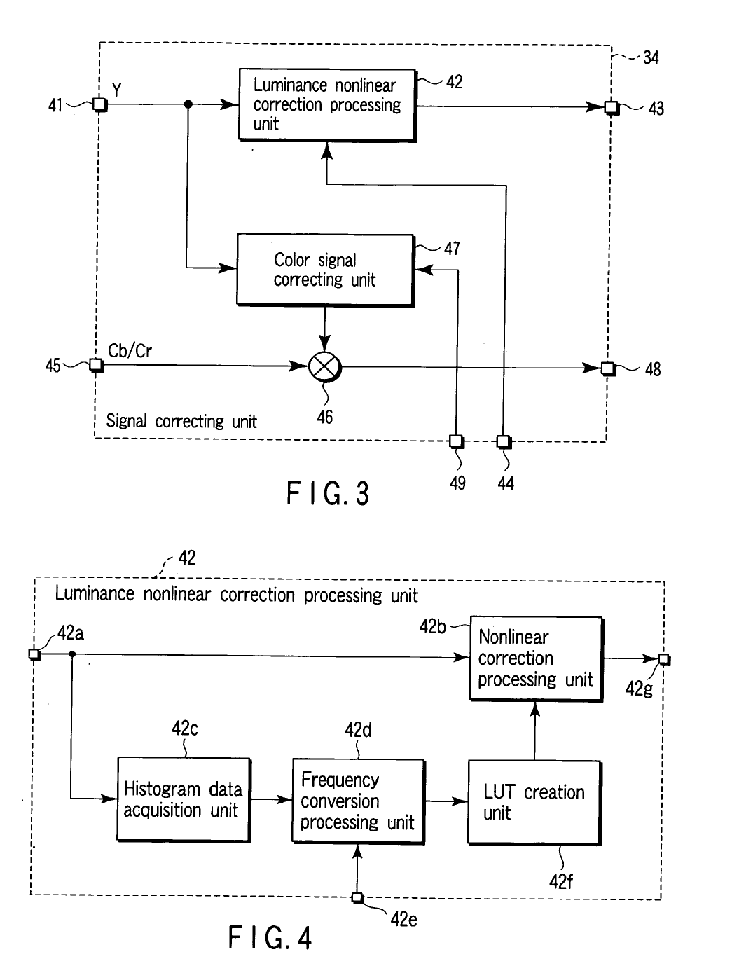

FIG. 3 shows an example of the above-described signal correcting unit 34. More specifically, the luminance signal Y output from the enhancer processing unit 33 is supplied to a luminance nonlinear correction processing unit 42 via an input terminal 41 to be subjected to a nonlinear correction processing for gradation correction. Then, the resulting signal is output to the color space converter unit 35 via an output terminal 43.

Here, the luminance nonlinear correction processing unit 42, although a detailed description will be given later, creates a lookup table (LUT) for luminance nonlinear correction processing on the basis of control data supplied from the control unit 26 to a control terminal 44, and then, applies a nonlinear correction processing to the luminance signal Y on the basis of the created LUT.

The color signal Cb/Cr output from the enhancer processing unit 33 is supplied to a multiplier 46 via an input terminal 45. The supplied signal is multiplied by a color correction signal output from a color signal correcting unit 47 to be thereby subjected to an amplitude control processing. Then, the resulting signal is output to the color space converter unit 35 via an output terminal 48.

On the basis of a level of the luminance signal Y supplied to the input terminal 41, the color signal correcting unit 47 makes a search for a color correction signal that is a color gain for making amplitude control in response to the color signal Cb/Cr, from the LUT for color correction processing, supplied from the control unit 26 to a control terminal 49, and then, outputs the resulting signal to the multiplier 46.

FIG. 4 shows a detail on the above-described luminance nonlinear correction processing unit 42. More specifically, the luminance signal Y supplied to the input terminal 41 passes through an input terminal 42a, and is then supplied to a nonlinear correction processing unit 42b and supplied to a histogram data acquisition unit 42c. Among them, the histogram data acquisition unit 42c acquires histogram data on each luminance level in response to input luminance signals for one frame.

Then, the histogram data acquired by the histogram data acquisition unit 42c is supplied to a frequency conversion processing unit 42d. The frequency conversion processing unit 42d, although a detailed description will be given later, applies to the input histogram data a frequency conversion processing based on control data supplied from the control unit 26 via control terminals 44, 42e, and then outputs the resulting data to an LUT creation unit 42f.

The LUT creation unit 42f creates an LUT for luminance nonlinear correction processing based on the histogram data subjected to the frequency conversion processing, the data being output from the frequency conversion processing unit 42d, and outputs the resulting data to the nonlinear correction processing unit 42b. Then, the nonlinear correction processing unit 42b applies a nonlinear correction processing based on the LUT to the input luminance signal, and outputs the resulting signal to the color space converter unit 35 via output terminals 42g, 43.

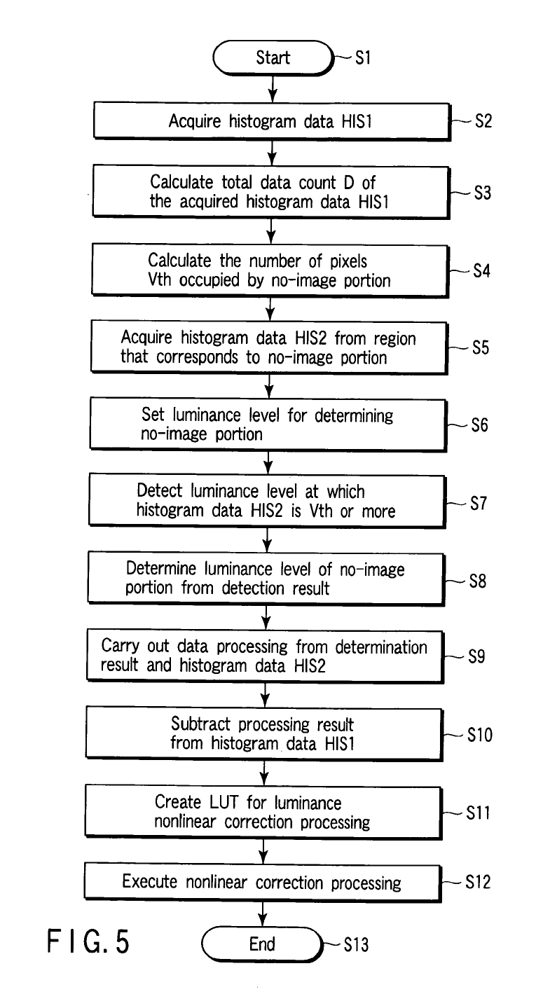

FIG. 5 is a flow chart collectively showing a series of nonlinear correction processing operations to be applied to the luminance signal Y by the luminance nonlinear correction processing unit 42. That is, when the processing is started (block S1), the histogram data acquisition unit 42c acquires histogram data HIS1 on each luminance level in block S2.

The histogram data HIS1 is acquired in such a manner that a dynamic range of a luminance level is n-divided to count the number of pixels corresponding to each of luminance levels 1 to n in response to an effective image in one frame of an input picture signal. In this case, the resolution of the luminance levels 1 to n is well finely set. For example, in the case where an input picture signal is 8 bits, the resolution of the luminance level for acquiring the histogram data HIS1 is also 8 bits.

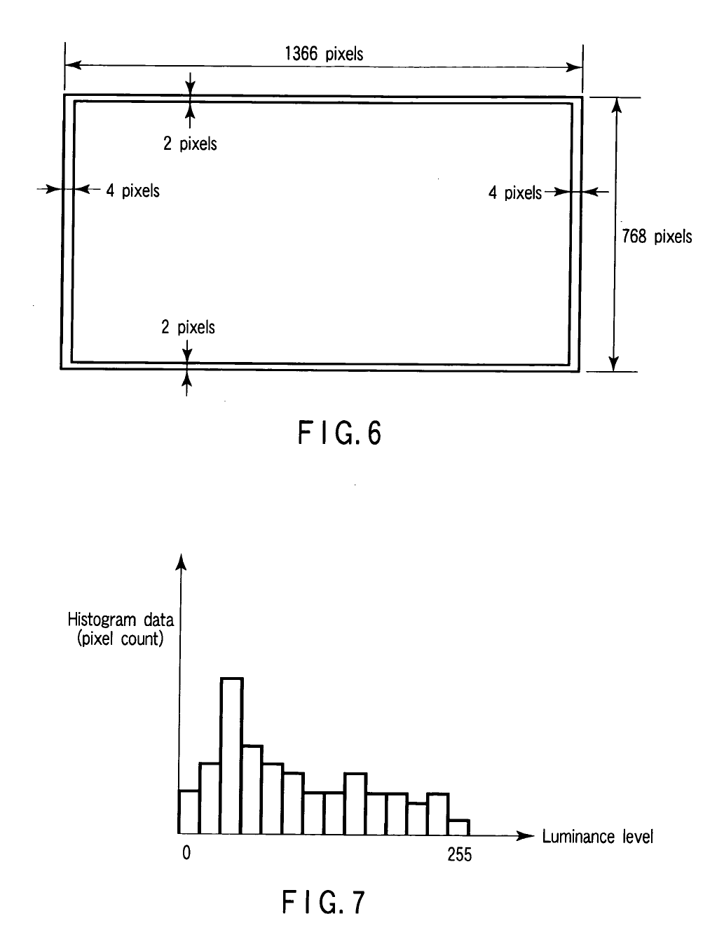

FIG. 6 shows an example of an effective image for acquiring luminance histogram data HIS1 by way of example of a picture signal (WXGA) of horizontal 1366 pixels×vertical 768 pixels. As this effective image, a range is recommended, the range excluding 4 pixels from the left and right ends of a screen for one frame and 2 pixels from the top and bottom ends thereof.

Information indicating the range of the effective image is assumed to have been stored in advance in the nonvolatile memory 30. As required, the information is read out from the nonvolatile memory 30 by means of the above control unit 26 to be supplied as control data to the frequency conversion processing unit 42d via the control terminals 44, 42e.

FIG. 7 shows an example of histogram data HIS1 acquired from an effective image for one frame in the above-described picture signal (WXGA). In this case, the resolution of the luminance level is 8 bits (0 to 255). That is, the number of pixels corresponding to each of 256 luminance levels from 0 to 255 is acquired. For this reason, when all of the histogram data (the number of pixels) HIS1 at the luminance levels are summed up, its total is equal to the number of pixels of the effective image in one frame of the input picture signal.

Thereafter, the frequency conversion processing unit 42d executes a frequency conversion processing on the basis of control data supplied from the control unit 26 with respect to the acquired histogram data HIS1. First, in block S3, the frequency conversion processing unit 42d calculates a total data count D of the luminance histogram data HIS1 acquired from the effective image in one frame of the picture signal (WXGA).

Then, in block S4, the frequency conversion processing unit 42d multiplies the total data count D by a parameter S (%) indicating a percentage of a range (area) occupied by a no-image portion in one frame of a picture signal of a letterbox system or in a side panel system, thereby calculating the number of pixels Vth occupied by a no-image portion in the effective image.

The parameter S (%) can take a value from 0% to 100%, and preset values are stored in the nonvolatile memory 30. As required, the values are read out from the nonvolatile memory 30 by means of the control unit 26 to be supplied as control data to the frequency conversion processing unit 42d via the control terminals 44, 42e.

Then, in block S5, the frequency conversion processing unit 42d acquires luminance histogram data HIS2 with respect to a marginal portion of its effective image from among one frame of the picture signal (WXGA). That is, the histogram data HIS2 is provided as the number of pixels of a region that corresponds to a no-image portion in one frame of a picture signal in a letterbox system or in a side panel system.

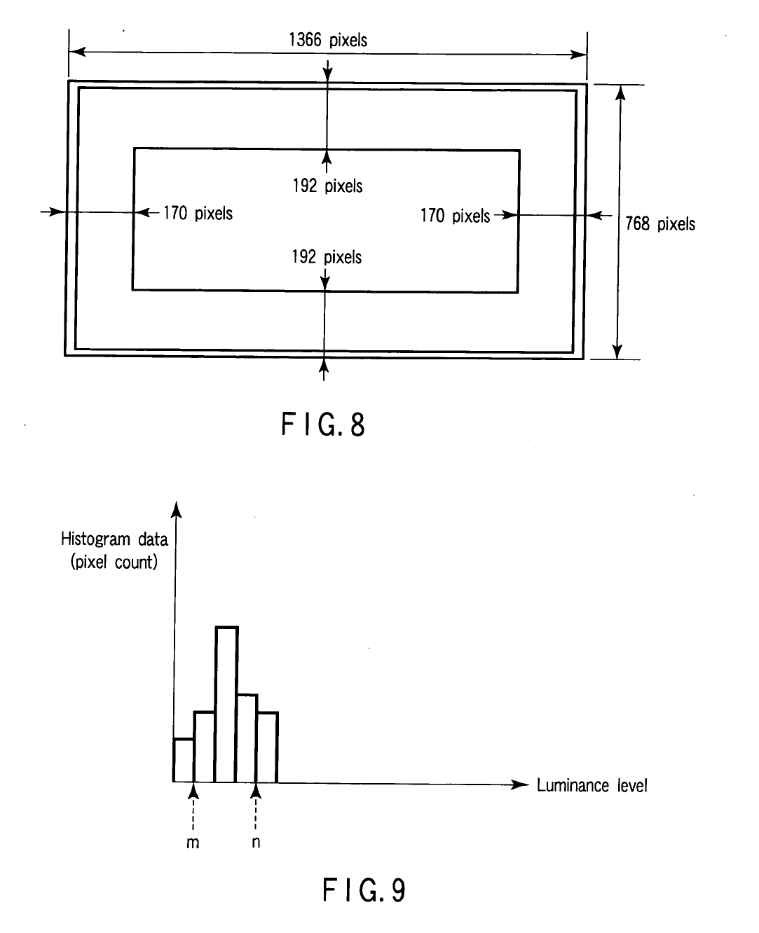

As an acquisition range of the histogram data HIS2, as shown in FIG. 8, there are recommended a frame-like portion in one frame of the above-described picture signal (WXGA), the frame-like portion being surrounded by a region occupied by 12.5% (170 pixels) from the left and right ends of the screen and a region occupied by 25% (192 pixels) from the top and bottom ends thereof.

Information indicating a range of the frame shaped portion is stored in advance in the nonvolatile memory 30. As required, the information is read out from the nonvolatile memory 30 by means of the control unit 26 to be supplied as control data to the frequency conversion processing unit 42d via the control terminals 44, 42e.

Then, the histogram data HIS2 can be obtained by acquiring histogram data contained in a screen center portion surrounded by the frame shaped range that is the acquisition range of the histogram data HIS2, namely, in a region that corresponds to an effective picture portion, and then, subtracting the acquired histogram data from the above histogram data HIS1. FIG. 9 shows an example of the thus acquired histogram data HIS2.

Next, in block S6, the frequency conversion processing unit 42d sets a range of a luminance level for determining a no-image portion of a picture signal in a letterbox system or in a side panel system. In this range, as shown in FIG. 9, values m to n of the preset luminance levels are stored in the nonvolatile memory 30. As required, the values are read out from the nonvolatile memory 30 by means of the control unit 26 to be supplied as control data to the frequency conversion processing unit 42d via the control terminals 44, 42e.

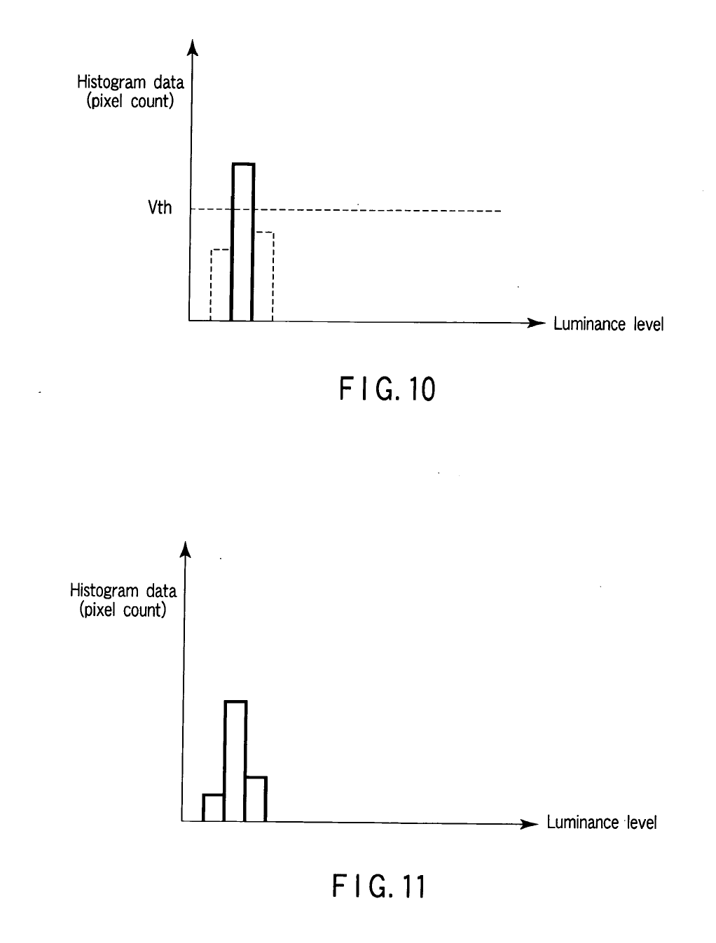

Then, in block S7, the frequency conversion processing unit 42d, as shown in FIG. 10, detects one or more of the luminance levels in the range set in block S6, the histogram data HIS2 having the number of pixels equal to or greater than the number of pixels Vth calculated in block S4.

In block S8, the frequency conversion processing unit 42d selects a luminance level that corresponds to a no-image portion of a picture signal in a letterbox system or in a side panel system, from among the luminance levels detected in block S7. For example, it is determined that from among the luminance levels detected in block S7, the most frequently existing histogram data HIS2 is a luminance level of a no-image portion of a current input picture signal.

Next, in block S9, the frequency conversion processing unit 42d executes a correction processing for a determination result obtained in block S8. More specifically, although there is no problem with a noise-free flat picture signal such as a graphics signal, data is scattered around due to noise to the periphery of an essential signal level in the case of a signal obtained by sampling an analog picture signal by an A/D converter unit. For this reason, there is a need for carrying out correction considering this scattering.

Thus, a coefficient is assigned to the luminance level determined in block S8, and the histogram data HIS2 is multiplied by the resulting luminance level. Consequently, as shown in FIG. 11, the data scattering around the luminance level determined in block S8 is made up as data on a no-image portion.

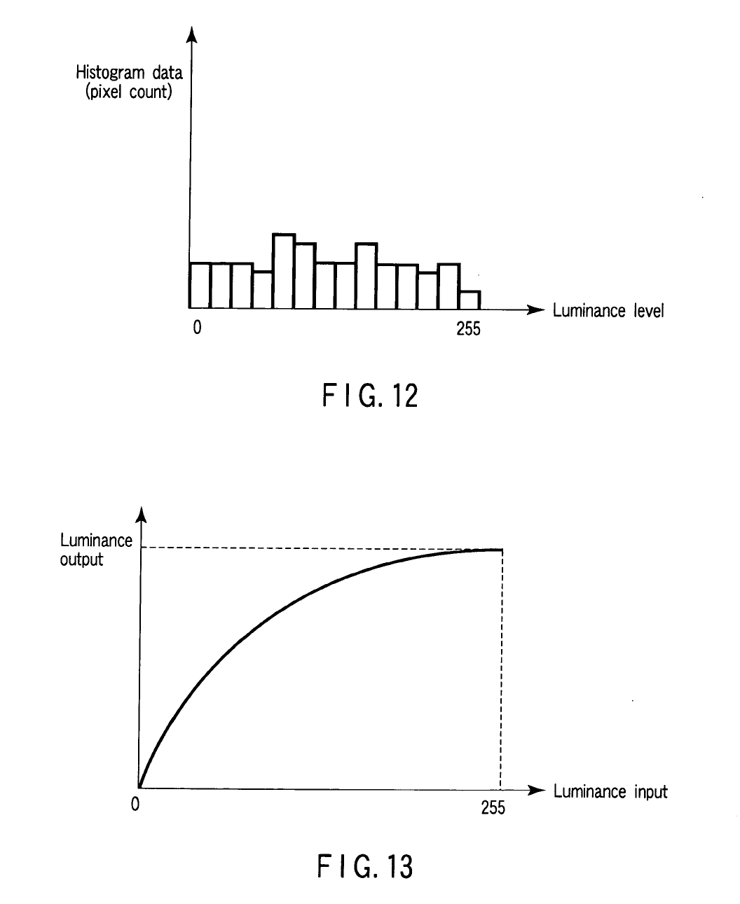

Thereafter, in block S10, the frequency conversion processing unit 42d subtracts the result obtained in block S9 from the histogram data HIS1. This result obtained in block S10 is produced as luminance histogram data after corrected, excluding a no-image portion in the letterbox system or in the side panel system from the input picture signal as shown in FIG. 12.

Then, in block S11, the LUT creation unit 42f cumulatively adds the corrected histogram data from the lower luminance level, thereby producing a luminance input/output converting parameter, namely, an LUT for luminance nonlinear correction processing. Then, in block S12, the linear correction processing unit 42b applies a nonlinear correction processing to the luminance signal Y on the basis of the LUT, and terminates the processing (block S13). FIG. 13 shows an example of nonlinear characteristics assigned to the luminance signal Y by means of the LUT for luminance nonlinear correction processing.

According to the above-described embodiment, histogram data is produced, the data excluding a no-image portion in the letter box system or in the side panel system from an input picture signal so as to apply a gradation correction processing to the luminance signal on the basis of the histogram data. Consequently, it becomes possible to apply an optimal gradation correction processing to an effective picture portion so as to enable luminance control suitable for practical use.

From the histogram data HIS2 acquired from a frame shaped region that corresponds to a no-image portion of the picture signal in the letterbox system or in the side panel system, the histogram data on a no-image portion included in the values m to n of the preset luminance levels are not subtracted from the histogram data HIS1. Instead, one or more having the number of pixels equal to or greater than the number of pixels Vth occupied by a no-image portion in an effective image is selected from among the histogram data. Further, among them, the data on a no-image portion, having the largest number of pixels, is subtracted from the histogram data HIS1. As a consequence, the precision of the finally obtained histogram data after corrected is remarkably improved. In this point of view as well, it becomes possible to apply an optimal gradation correction processing to an effective picture portion so as to enable luminance control suitable for practical use.

As described above, from among the histogram data included in the values m to n of the present luminance levels, one or more having the number of pixels equal to or greater than the number of pixels Vth occupied by a no-image portion in an effective image is selected. Further, among them, the histogram data on a no-image portion, having the largest number of pixels is subtracted from the histogram data HIS1. Accordingly, even in the case where data is intensively present in the vicinity of the luminance levels m to n for determining a no-image portion, it is possible to prevent extreme change of gradation correction characteristics.

Moreover, in the above-described embodiment, the region of the effective image shown in FIG. 6, the frame shaped region shown in FIG. 8, the parameter S (%), the values m to n of the luminance levels for determining a no-image portion, and the like can be easily changed merely by varying the contents of the nonvolatile memory 30. As a result, there occurs an advantageous effect that a manufacturing work is facilitated.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1.-12. (canceled)

13. A broadcast receiver, comprising:
a receiver unit configured to receive a broadcast signal;
a first restore unit configured to restore a luminance signal from the broadcast signal received at the receiver unit;
an acquisition unit configured to acquire histogram data on each luminance level in an identified center portion of a screen from luminance signals for one frame restored at the first restore unit;
a creation unit configured to create a nonlinear correction processing table for applying a nonlinear correction processing to the luminance signal restored at the first restore unit on the basis of the histogram data subjected to a frequency conversion processing at a frequency converter unit; and
a processing unit configured to apply a nonlinear correction processing to the luminance signal restored at the first restore unit on the basis of the nonlinear correction processing table created at the creation unit.

14. The broadcast receiver according to claim 13, wherein the acquisition unit includes:
a histogram acquisition unit configured to acquire histogram data on each luminance level from luminance signals for one frame received by the receiver unit; and
the frequency converter unit configured to eliminate histogram data corresponding to a no-image portion, which is displayed to occupy a predetermined region in a screen, from among the histogram data on each luminance level acquired at the histogram acquisition unit, when a video image having an aspect ratio different from an aspect ratio of the screen is displayed on the screen.

15. The broadcast receiver according to claim 14, wherein the frequency converter unit comprises:
a first circuit unit configured to acquire histogram data on each luminance level from the identified center portion of the screen in response to the luminance signals for one frame input to the input unit, wherein the identified center portion is a predetermined region preset at a center portion of a screen;
a second circuit unit configured to subtract the histogram data of the identified center portion from histogram data of an effective image portion of the screen;
a third circuit unit configured to detect histogram data that corresponds to the no-image portion on the basis of a preset value from among the histogram data obtained at the second circuit unit; and
a fourth circuit unit configured to subtract the histogram data detected at the third circuit unit from the histogram data of the effective image portion on the screen.

16. The broadcast receiver according to claim 15, wherein the third circuit unit comprises:
a fifth circuit unit configured to select, from among the histogram data obtained at the second circuit unit, histogram data items that corresponds to a plurality of luminance levels preset to determine a no-image portion; and
a sixth circuit unit configured to select, from among the histogram data items selected at the fifth circuit unit, a histogram data item indicating a number of pixels greater than a preset number of pixels that correspond to the no-image portion and are included in a one-frame luminance signal.

17. The broadcast receiver according to claim 16, wherein the sixth circuit unit comprises:
a seventh circuit unit configured to calculate a total data count of the histogram data on each luminance level acquired at the acquisition unit; and
an eighth circuit unit configured to multiply the total data count calculated at the seventh circuit unit by a parameter preset as a percentage occupied by a no-image portion in luminance signals for one frame,
wherein an output value of the eighth circuit unit is configured to be the number of pixels occupied by a no-image portion in luminance signals for one frame.

18. The broadcast receiver according to claim 15, wherein the third circuit unit is configured to detect the most frequently existing histogram data that corresponds to a no-image portion, from among the histogram data detected at the sixth circuit unit.

19. The broadcast receiver according to claim 14, wherein the frequency converter unit is configured to eliminate histogram data that corresponds to a no-image portion included in picture signals of at least one of a letterbox system and a side panel system from among the histogram data on each luminance level acquired at the acquisition unit.

20. The broadcast receiver according to claim 13, further comprising:
a second restore unit configured to restore a color signal from the broadcast signal received at the receiver unit;
a correcting unit configured to apply an amplitude correction processing on the basis of the luminance signal restored at the first restore unit to the color signal restored at the second restore unit; and
a display unit configured to make a picture display on the basis of the color signal subjected to an amplitude correction processing at the correcting unit and a luminance signal subjected to a nonlinear correction processing at the processing unit.

21. A broadcast receiving method, comprising:
receiving a broadcast signal;
restoring a luminance signal from the received broadcast signal;
acquiring histogram data on each luminance level in an identified center portion of a screen from the restored luminance signals for one frame;
creating a nonlinear correction processing table for applying a nonlinear correction processing to the restored luminance signal on the basis of the histogram data subjected to a frequency conversion processing; and
applying a nonlinear correction processing to the restored luminance signal on the basis of the created nonlinear correction processing table.

22. The broadcast receiving method according to claim 21, wherein the step of acquiring histogram data further comprises:
acquiring histogram data on each luminance level from the received luminance signals for one frame; and
eliminating histogram data corresponding to a no-image portion, displayed to occupy a predetermined region in a screen, from among the histogram data on each acquired luminance level, when a video image having an aspect ratio different from an aspect ratio of the screen is displayed on the screen.

23. The broadcast receiving method according to claim 22, wherein the step of eliminating histogram data further comprises:
a first step of acquiring histogram data on each luminance level from a predetermined region preset at the identified center portion of the screen in response to the received broadcast signal;
a second step of subtracting the histogram data acquired in the first step from histogram data of an effective image portion of the screen;
a third step of detecting histogram data that corresponds to the no-image portion on the basis of a preset value from among the histogram data obtained in the second step; and
a fourth step of subtracting the histogram data detected in the third step from the histogram data of an effective image portion of the screen.

24. The broadcast receiving method according to claim 23, wherein the third step comprises:
a fifth step of selecting, from among the histogram data obtained in the second step, histogram data items that corresponds to a plurality of luminance levels preset to determine a no-image portion; and
a sixth step of selecting, from among the histogram data items selected in the fifth step, a histogram data item indicating a number of pixels greater than a preset number of pixels that correspond to the no-image portion and are included in a one-frame luminance signal.

25. The broadcast receiving method according to claim 24, wherein the sixth step comprises:
a seventh step of calculating a total data count of the histogram data of an effective image portion of the screen; and
an eighth step of multiplying the total data count calculated in the seventh step by a parameter preset as a percentage occupied by a no-image portion in luminance signals for one frame,
wherein an output value of the eighth step is operated to be the number of pixels occupied by a no-image portion in luminance signals for one frame.

26. The broadcast receiving method according to claim 24, wherein the third step is operated to detect the most frequently existing histogram data that corresponds to a no-image portion, from among the histogram data detected in the sixth step.

27. The broadcast receiver according to claim 14, wherein a determination that the aspect ratio of the video data displayed on the screen is different from the aspect ratio of the screen causes the display of the no-image portion.

28. The broadcast receiving method according to claim 22, wherein a determination that the aspect ratio of the video data displayed on the screen is different from the aspect ratio of the screen causes the display of the no-image portion.
